(19) United States
(12) Patent Application Publication
(10) Pub. No.: US 2017/0030659 A1
(43) Pub. Date: Feb. 2, 2017

(54) Tube-and-Fin Assembly with Improved Removal Feature and Method of Making Thereof

(71) Applicant: Caterpillar Inc., Peoria, IL (US)

(72) Inventor: Joseph Kennedy, Peoria, IL (US)

(73) Assignee: Caterpillar Inc., Peoria, IL (US)

(21) Appl. No.: 14/811,117

(22) Filed: Jul. 28, 2015

(51) Int. Cl. F28F 1/20; F28F 9/26; B23P 15/26; F28F 3/04

(52) U.S. Cl. CPC F28F 1/20; F28F 3/04; F28F 9/262; B23P 15/26

(57) ABSTRACT

A tube-and-fin assembly with improved removal feature is provided. The tube-and-fin assembly includes a tube including an elongated body having flattened sides, a cylindrical top end and a cylindrical bottom end for attachment to a coolant manifold, and a plurality of fins which are disposed as a unitary part of a corrugated sheet affixed to either side of the tube, where the bottom end includes a bottom bead and a top bead.

### TECHNICAL FIELD

This disclosure relates generally to tube-and-fin style heat exchangers. More particularly, this disclosure relates to a tube-and-fin assembly with a removal feature and method of making thereof.

### BACKGROUND

Large heavy duty machines such as track-type tractors, loaders, off highway trucks and excavators require large radiators for engine cooling. In addition, many modern vehicles carry an additional heat exchanger for cooling the fluid present in automotive transmissions used in connection with these liquid-cooled engines, and some vehicles employ oil coolers for cooling the engine oil. These supplemental heat exchangers and oil coolers utilize a coolant which passes through the radiator of the engine cooling system for cooling the transmission fluid or engine oil.

In order to transfer heat effectively from the liquid coolant to the surrounding air, radiator cores are generally constructed of relatively thin, heat conductive materials. One common radiator design is the tube-and-fin structure, where numerous tube-and-fin assemblies are mounted to coolant manifolds and arranged in columns and rows.

The tube-and-fin assemblies that make up a radiator are typically secured to the coolant manifolds and sealed thereto with flexible grommets or seals. The tubes may include a bead circumferentially disposed around a lower end of the tube, and the seals include a circumferential groove for receiving the bead to hold the tube-and-fin assembly in place. One such tube and seal construction is disclosed in U.S. Pat. Pub. No. 2014/0182829, which describes a heat exchange assembly.

The radiator cores are placed in a vehicle in a location where they will be exposed to cooling air. As a result of such a relatively delicate construction and the exposed location of radiators, the radiator cores are vulnerable to damage from a variety of road hazards such as flying stones, gravel and other debris, as well as being vulnerable to accidental damage as a result of collision. Additionally, radiator cores are susceptible to damage from corrosion, extreme heat, or extreme cold. Very often, such damage results in puncture of the radiator core with a resultant loss of coolant and complete failure of the cooling system. It becomes necessary to repair a damaged tube-and-fin assembly in the radiator cores. In general, the damaged tube-and-fin assembly is removed with a tube removal tool. However, when the tube removal tool grips a section of the tube for removal, the section becomes physically and irreparably damaged, which makes it difficult to reuse the whole tube-and-fin assembly. These and other shortcomings of the prior art are addressed by the present disclosure.

### SUMMARY

The disclosure is directed toward solving issues with a conventional tube-and-fin assembly. In one aspect of the disclosure, a tube-and-fin assembly is provided. The tube-and-fin assembly includes a tube having an elongated body having flattened sides, a cylindrical top end and a cylindrical bottom end for attachment to a coolant manifold, where the bottom end includes a bottom bead and a top bead. The tube-and-fin assembly further includes a plurality of fins which are disposed as a unitary part of a corrugated sheet affixed to either side of the tube.

In another aspect of the disclosure, a method for manufacturing a tube-and-fin assembly is provided. The method includes preparing a tube including an elongated body having flattened sides connected by rounded ends, where the rounded ends include a cylindrical top end and a cylindrical bottom end for attachment to a coolant manifold, integrally forming a bottom bead as part of the bottom end, configuring the bottom bead to at least partially secure the tube to the coolant manifold by fitting within a groove formed in a seal of the coolant manifold, integrally forming a top bead on the bottom end wherein the top bead is spaced apart from the bottom bead along a longitudinal direction of the tube, and affixing a plurality of fins to either side of the tube, where the fins are disposed as a unitary part of a corrugated sheet.

In another aspect of the disclosure, a method for removing a tube-and-fin assembly in a cooling core assembly is provided. The method includes preparing a tube removal tool, where part of the tube removal tool is configured to fit in a section between a top bead and a bottom bead in a tube of the tube-and-fin assembly, firmly gripping the section between the top bead and the bottom bead with the part of the tube removal tool, and dissociating the bottom bead from a coolant manifold by moving the tube with the tube removal tool where the bottom bead is pulled up and separated from the coolant manifold. The tube-and-fin assembly includes a tube having an elongated body having flattened sides, a cylindrical top end and a cylindrical bottom end for attachment to the coolant manifold where the bottom end includes the bottom bead and the top bead, and a plurality of fins which are disposed as a unitary part of a corrugated sheet affixed to either side of the tube.

### BRIEF DESCRIPTION OF THE DRAWINGS

FIG. 1 illustrates a side view of an exemplary work machine that incorporates features of the disclosure.

FIG. 2 shows an elevation view of an exemplary cooling core assembly that includes fins and tubes according to the disclosure.

FIG. 3 shows a perspective view of an exemplary tube-and-fin assembly according to the disclosure.

FIG. 4 shows a partial perspective view of the bottom portion of the tube-and-fin assembly of FIG. 3 with a grommet or seal.

FIG. 5 shows a close-up view of a bottom portion of a tube according to the disclosure.

FIG. 6 illustrates an exemplary method of removing a tube-fin-assembly in a cooling core assembly according to the disclosure.

### DETAILED DESCRIPTION

While the disclosure is susceptible to various modifications and alternative forms, specific embodiments thereof have been shown by way of example in the drawings and will herein be described in detail. It should be understood, however, that there is no intent to limit the invention to the particular form disclosed, but on the contrary, the intention is to cover all modifications, equivalents, and alternatives falling within the spirit and scope of the disclosure as disclosed herein.

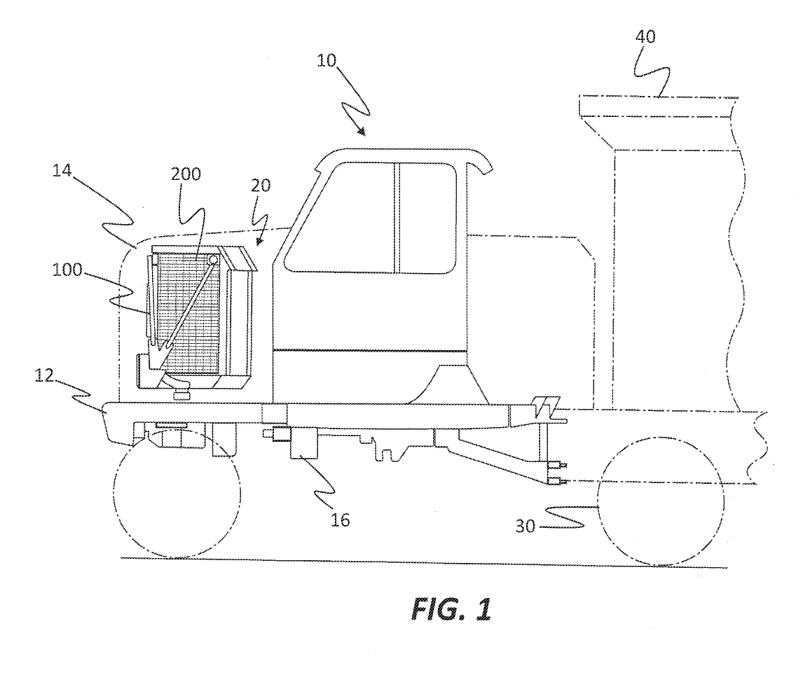

Referring to the drawings, and initially to FIG. 1, there is shown an exemplary work machine 10 which incorporates the features of the present disclosure therein. The work machine 10 may include a main frame 12, an engine assembly 14, a radiator assembly 20, a ground engaging mechanism 30 and a transmission assembly 16. The work machine 10 may further include a work implement 40.

The ground engaging mechanism 30 may include wheels as specifically shown in FIG. 1. In the alternative, the ground engaging mechanism 30 can also include a track change (not shown) of the type typically utilized on crawler tractors. Moreover, it should be understood that the work implement 40 can include a truck bed as shown in FIG. 1. In the alternative, the work implement 40 can include other types of work implements such as a bucker for moving earth or an earth moving blade of the type typically found on crawler tractors.

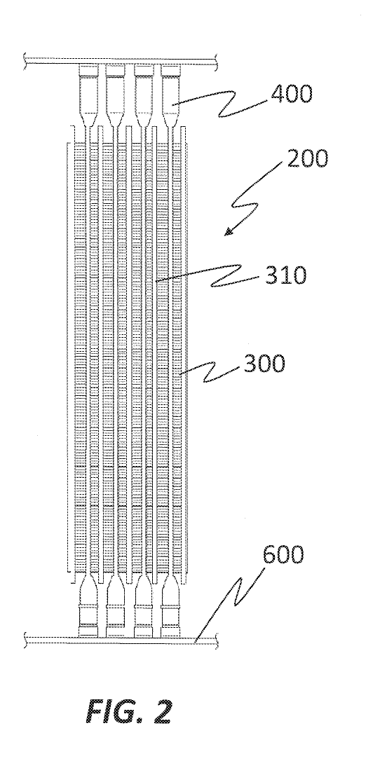

As shown in FIG. 1, the radiator assembly 20 may include a radiator fan 100 and a cooling core assembly 200 with an upper edge, a fluid inflow surface and a fluid outflow surface. The radiator assembly 20 may also include a frame which supports the cooling core assembly 200. The cooling core assembly 200 includes fins 300 (shown in FIG. 2) and tubes 400 (shown in FIG. 2).

FIG. 2 illustrates an exemplary cooling core assembly 200 that includes fins 300 and tubes 400. In one aspect, the fins 300 may be in corrugated fin structures. The tubes 400 and the fins 300 are arranged into a stack. In one aspect, the cooling core assembly 200 may include side separators 310. The side separators 310 and the tubes 400 may be alternatively spaced with respect to each other to minimize a distortion of the cooling core assembly 200 due to thermal expansion of the fins 300 and tubes 400. At least one of the tubes 400 is configured for attachment to coolant manifolds 600

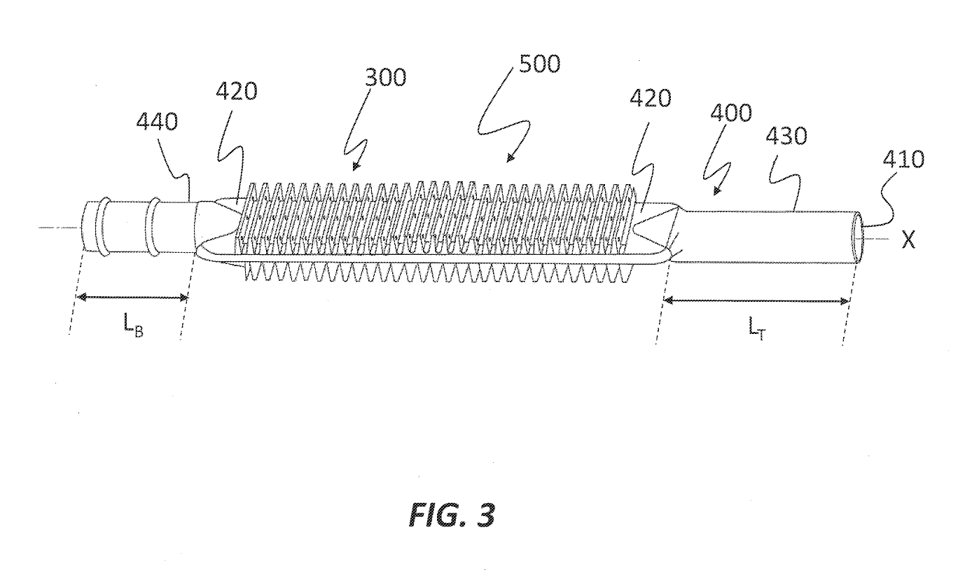

FIG. 3 illustrates a perspective view of a tube-and-fin assembly 500 in the cooling core assembly 200 (shown in FIG. 2). The tube-and-fin assembly 500 includes at least one of the tubes 400 and a plurality of the fins 300. According to the present disclosure, the tube 400 of the tube-and-fin assembly 500 may include a generally elliptical, cylindrical and/or elongated body 410 having flattened sides 420 connected by rounded ends 430, 440 and defining an axis X. The tube 400 may include a generally cylindrical top end 430 and a generally cylindrical bottom end 440 for attachment to coolant manifolds 600 (shown in FIG. 2). In one aspect, the length L_{B} of the bottom end 440 may be equal to or longer than the length L_{T} of the top end 430. The fins 300 may be disposed as indivisible and/or unitary part of a corrugated sheet affixed to either side 420 of the tube 400. The corrugated sheet, and thus the fins 300 may be welded, brazed or otherwise affixed to the sides 420 of the tube 400. In one aspect, the tube-and-fin assembly 500 may be a copper grommetted tube (CGT) assembly where the tube 400 and the fins 300 are both made of copper or copper alloy. The CGT assembly typically has a fin density D of 22 fins per inch (FPI) and a typical fin thickness T of about 0.1 mm. The tube thickness in the CGT assembly is also very small. Each fin 300 may extend radially outward from a side 420 of the tube 400. A flat tube 400 may be either extruded and/or drawn in the flat shape from a billet of material and cut into discrete lengths. Alternatively, a flat tube 400 is manufactured in a tube mill from coiled sheet by forming the sheet into a round shape, seam welding, roll flattening to the flat tube shape, and cutting into discrete tube lengths.

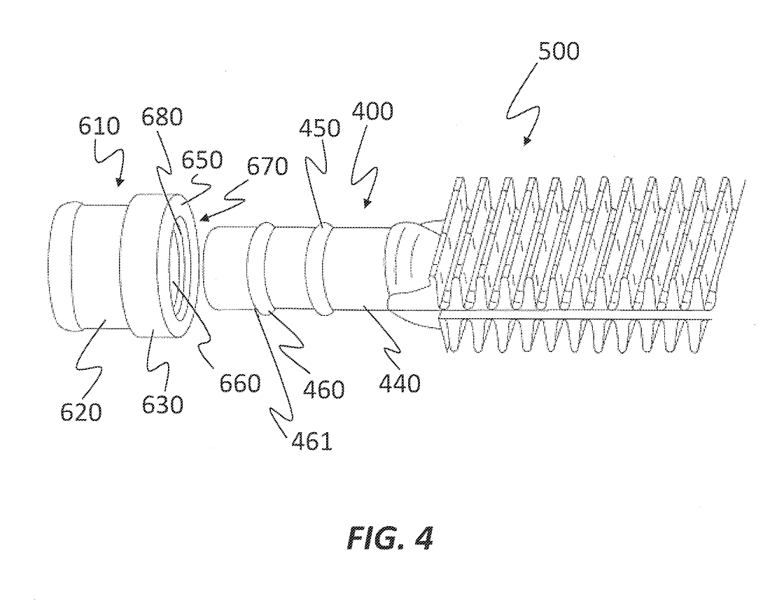

FIG. 4 is a partial perspective view of the bottom end 440 of the tube 400 in the tube-and-fin assembly 500 with a grommet or seal 610. The seal 610 may be integrally inserted in a coolant manifold 600 (shown in FIG. 2) to fluidly connect the tube-and-fin assembly 500 with the coolant manifold 600. The seal 610 may be made of rubber or other flexible material. The seal 610 may include a substantially cylindrical body 620, a flange portion 630 extending outward from the body 620 and having a top surface 650 and an inner wall 660 defining a bore 670. The inner wall 660 further defines a groove 680 disposed circumferentially about a portion of the inner wall 660 opposite the flange 630 and configured to receive a bottom bead 460.

In certain aspects of the present disclosure, the bottom end 440 of the tube 400 in the tube-and-fin assembly 500 may have two beads 450, 460 where a top bead 450 is spaced apart from a bottom bead 460. The bottom bead 460 may be formed circumferentially around the bottom end 440. The bottom bead 460 may be integrally formed as part of an extruded tube 400 and designed to help secure the tube 400 to a coolant manifold 600 by fitting within the groove 680 formed in the seal 610. For example, to connect the tube-and-fin assembly 500 with the seal 610, the tube-and-fin assembly 500 is inserted into the bore 670 until the bottom bead 460 impinges on the top surface 650 of the seal 610. The bottom bead corner 461 flares out the top surface 650 of the seal 610. The tube-and-fin assembly 500 is pushed into the bore 670 until the bottom bead 460 is captured within the groove 680.

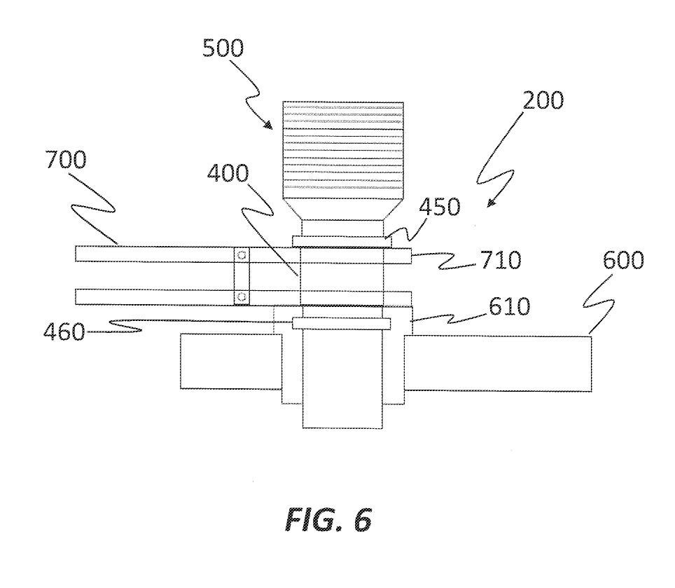

The top bead 450 may be formed circumferentially around the bottom end 440 and is spaced apart from the bottom bead 460 along the longitudinal direction of the tube 400. The distance between the top bead 450 and bottom bead 460 is configured to accommodate a tube removal tool 700 (shown in FIG. 6) between the two beads, 450, 460. Due to the presence of the two beads 450, 460 in the bottom end 440, the length of the bottom end may be longer than the length of a bottom end of a conventional tube with a single bead. In one aspect, the length L_{B} of the bottom end 440 may be longer than the length L_{T} of the top end 430 (shown in FIG. 3).

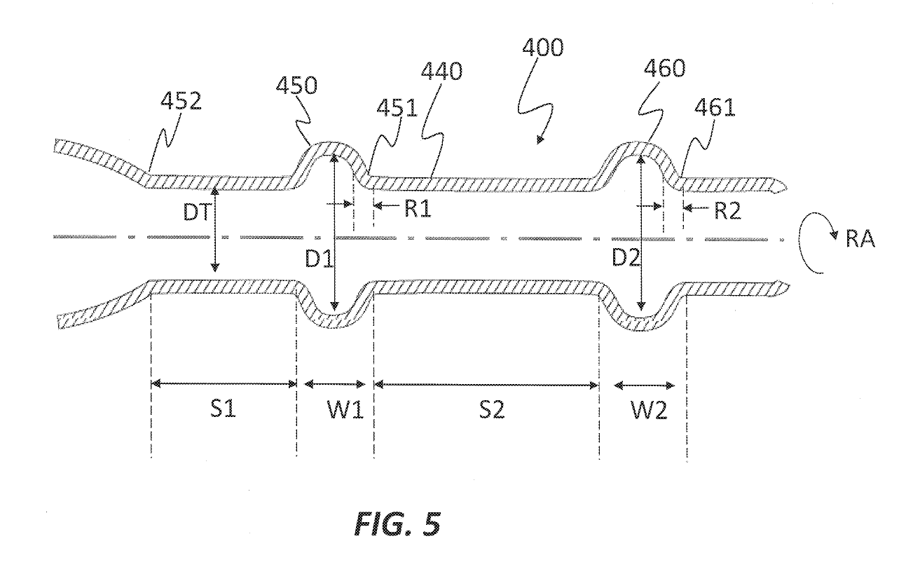

FIG. 5 is a close-up view of the bottom end 440 of the tube 400 according to the disclosure. In accordance with an aspect of the disclosure, the bottom bead 460 may include a bottom bead corner 461 which serves to flare out the seal 610 (shown in FIG. 4) when the bottom bead 460 impinges on the top of surface of the seal 610 during insertion of the tube 400 into the seal 610. The bottom bead corner 461 is a smooth, three-dimensional and circumferential curved shaped surface between the bottom bead 460 and the cylindrical bottom end 440 where the bottom bead 460 and the tube bottom end 440 are joined. In one aspect, the bottom bead corner 461 may be a frustoconical curved shaped surface which is a three-dimensional surface shaped like a truncated cone but with an inwardly curved surface.

The bottom bead corner 461 extends from the bottom bead 460 to the tube bottom end 440. When viewed from outside of the tube 400, the bottom bead 460 is generally convex while the bottom bead corner 461 is generally concave. The bottom end 440 appears flat or straight. Thus the bottom bead corner 461 extends from a top inflection circle to a bottom inflection circle. Near the top inflection point, the curvature of the tube exterior surface changes from convex to concave whereas near the bottom inflection point the surface of the tube 400 changes from concave to flat. The exterior surface of the tube 400 along the bottom bead corner 461 may be a smooth upside down bell shape. As a result of this geometry, just before the bottom bead 460 impinges on the top surface of the seal 610, the bottom bead corner 461 helps flare out the seal 610, thereby making easier insertion of the tube 400 into the seal 610.

The top bead 450 may be spaced apart from the bottom bead 460 along the longitudinal direction of the bottom end 440. Similar to the bottom bead 460, the top bead 450 may include a top bead corner 451. The top bead 450 is configured to serve as a blockage which prevents a tube removal tool 700 (shown in FIG. 6) from slipping along the tube 400 when the tube removal tool 700 grips and pulls up the tube 400. For example, to dissociate the tube-and-fin assembly 500 from the seal 610, a tube removal tool 700 is inserted into a section between the top bead 450 and the bottom bead 460. As the tube removal tool 700 grips the section and pulls up the tube-and-fin assembly 500 to dissociate the tube-and-fin assembly 500 from the seal 610, the top bead 450 blocks the tube removal tool 700 from slipping along the tube 400 and thus prevents the tube 400 from being damaged beyond the section.

The distance between the bottom bead 460 and the top bead 450 is configured for a tube removal tool 700 to fit in between the two beads, 450, 460. In one aspect, the distance S1 between the tapered tube neck 452 and the top bead 450 may be equal to or less than the distance S2 between the top bead 450 and the bottom bead 460, which is configured to prevent the tube 400 beyond the gripping section from being bent or damaged when the tube removal tool 700 pulls up the tube 400. The diameter D1 of the top bead 450 may be equal to the diameter D2 of the bottom bead 460. In some aspects, the diameter D1 of the top bead 450 may be larger than the diameter D2 of the bottom bead 460. The width W1 of the top bead 450 may be equal to the width W2 of the bottom bead 460. In certain aspects, the width W1 of the top bead 450 may be larger than the width W2 of the bottom bead 460.

The minimum radii of curvature R2 of the bottom bead corner 461, i.e., the vertical distance between the top and bottom inflection planes, may be equal to the minimum radii of curvature R1 of the top bead corner 451, i.e., the vertical distance between the top and bottom inflection planes. In one aspect, the minimum radii of curvature R1 may be different from the minimum radii of curvature R2 to provide strong resistance to prevent a tube removal tool 700 from slipping along the tube 400 when the tube removal tool 700 grips and pulls up the tube 400.

Each of the beads 450, 460 may circumferentially surround the tube 400. The arc angle RA of the top bead 450 surrounding the tube 400 may be in a range of from 180 to 360°. In one aspect, the top bead 450 may be divided into a plurality of sections each of which is equally spaced around a circumference of the bottom end 440. In a copper grommetted tube (CGT) assembly, for example, the operable radii of each of curvatures R1, R2 may be in a range of from about 0.2 mm to at least about 0.5 mm. The distance between the top bead 450 and the bottom bead 460 may be in a range of from about 7 mm to about 9 mm. The distance between the tube neck 452 and the top bead 450 may be in a range of from about 7 mm to about 9 mm. The diameter DT of the tube 400 may be in a range of from about 11 mm to about 13 mm. The diameter D1, D2 of each of the beads 450, 460 may be in a range of about 13 mm to about 16 mm. The width W1, W2 of each of the beads 450, 460 may be in a range of about 1 mm to about 3 mm. In one aspect, the width W1 of the top bead 450 may be about 2 mm.

FIG. 6 illustrates an exemplary method of removing a tube-and-fin assembly 500 in a cooling core assembly 200 in according to the disclosure. The tube removal tool 700 such as a wrench, a spanner, or the like is inserted in order to loosen the tube-and-fin assembly 500. Part 710 of the tube removal tool 700 is configured to fit in between the top bead 450 and the bottom bead 460 to grip the tube 400. To dissociate the tube-and-fin assembly 500 from the seal 610 inserted in the coolant manifold 600, the part 710 of the tube removal tool 700 is inserted in a section between the top bead 450 and the bottom bead 460. The part 710 of the tube removal tool 700 grips the section and pulls up the tube-and-fin assembly 500 to dissociate the tube-and-fin assembly 500 from the seal 610 while the top bead 450 blocks the tube removal tool 700 from slipping along the tube 400 and thus prevents the tube 400 from being damaged beyond the section. As the bottom bead 460 is dissociated from the seal 610, the tube-and-fin assembly 500 can be removed from the cooling core assembly 200. By limiting the gripping within the section between the top bead 450 and the bottom bead 460 of the tube 400 during removal of the tube-and-fin assembly 500, the tube 400 and the tube-and-fin assembly 500 can remain reparably reusable.

### INDUSTRIAL APPLICABILITY

The disclosure may be applicable to any liquid cooling system where transferring heat effectively from the liquid coolant to the surrounding air via a tube-and-fin assembly is desired. Specifically, the disclosure may include a cooling core assembly 200 which regularly needs replacement of a tube-and-fin assembly 500 in the cooling core assembly 200.

The tube-and-fin assembly 500 described herein may be made of copper or copper alloy. Alternatively, the tube-and-fin assembly 500 may be made of aluminum or aluminum alloy. In some aspects, the tube-and-fin assembly 500 may be made of any type of materials which provide desired heat transfer performance. The tube-and-fin assembly 500 may be used as a component of large radiators used in heavy duty machines, especially where cost and performance are design factors. The tube-and-fin assembly 500 may also be used in an after-market, drop-in, replacement for existing tube-and-fin assemblies.

The disclosure is universally applicable for use in a liquid cooling core assembly 200 for many types of off highway machines, such as, for example, machines associated with industries such as mining, construction, farming, transportation, etc. For example, the machine 10 may be a tractor, mining truck, on-highway truck, car, vehicle, off-highway truck, earth moving equipment, material handler, logging machine, compactor, construction equipment, stationary power generator, pump, locomotive, mining machine, or any other device or application that may utilize a tube-and-fin assembly 500 as disclosed herein. Similarly, the disclosure is universally applicable for use in a liquid cooling core assembly 200 for many types of generator sets that typically include a generator and a prime mover.

It is understood that the embodiments of the disclosure described above are only particular examples which serve to illustrate the principles of the disclosure. Modifications and alternative embodiments of the disclosure are contemplated which do not depart from the scope of the disclosure as defined by the foregoing teachings and appended claims. It is intended that the claims cover all such modifications and alternative embodiments that fall within their scope.

We claim:

1. A tube-and-fin assembly, comprising:
a tube comprising an elongated body having flattened sides, a cylindrical top end and a cylindrical bottom end for attachment to a coolant manifold, wherein the bottom end comprises a bottom bead and a top bead; and
a plurality of fins disposed as a unitary part of a corrugated sheet affixed to either side of the tube.

2. The tube-and-fin assembly according to claim 1, wherein the bottom bead is integrally formed as part of the bottom end and configured to at least partially secure the tube to the coolant manifold by fitting within a groove formed in a seal of the coolant manifold.

3. The tube-and-fin assembly according to claim 1, wherein the top bead is formed circumferentially around the bottom end and is spaced apart from the bottom bead along a longitudinal direction of the tube.

4. The tube-and-fin assembly according to claim 1, wherein a distance between the top bead and the bottom bead is configured to accommodate a tube removal tool between the two beads.

5. The tube-and-fin assembly according to claim 1, wherein the tube and the fins are made of a copper alloy.

6. The tube-and-fin assembly according to claim 1, wherein the tube further comprises a tapered tube neck and a distance between the tapered tube neck and the top bead is equal to or less than a distance between the top bead and the bottom bead.

7. The tube-and-fin assembly according to claim 1, wherein a diameter of the top bead is equal to or larger than a diameter of the bottom bead.

8. The tube-and-fin assembly according to claim 1, wherein a minimum radii of curvature in a top corner of the top bead is different from a minimum radii of curvature in a bottom corner of the bottom bead.

9. The tube-and-fin assembly according to claim 1, wherein an arc angle of the top bead surrounding the tube is in a range of from 180 to 360°.

10. The tube-and-fin assembly according to claim 1, wherein the top bead comprises a plurality of sections each of which is equally spaced around a circumference of the bottom end.

11. The tube-and-fin assembly according to claim 1, wherein a width of the top bead is equal to a width of the bottom bead.

12. A method for manufacturing a tube-and-fin assembly, comprising:
preparing a tube including an elongated body having flattened sides connected by rounded ends, wherein the rounded ends include a cylindrical top end and a cylindrical bottom end for attachment to a coolant manifold;
integrally forming a bottom bead as part of the bottom end;
configuring the bottom bead to at least partially secure the tube to the coolant manifold by fitting within a groove formed in a seal of the coolant manifold;
integrally forming a top bead on the bottom end wherein the top bead is spaced apart from the bottom bead along a longitudinal direction of the tube; and
affixing a plurality of fins to either side of the tube, wherein the fins are disposed as a unitary part of a corrugated sheet.

13. The method according to claim 12, further comprising:
configuring a distance between the top bead and bottom bead for a tube removal tool to fit in between the top bead and the bottom bead.

14. The method according to claim 12, further comprising:
configuring a diameter of the top bead to be equal to or larger than a diameter of the bottom bead.

15. The method according to claim 12, further comprising:
configuring a minimum radii of curvature in a top corner of the top bead to be different from a minimum radii of curvature in a bottom corner of the bottom bead.

16. The method according to claim 12, further comprising:
configuring a distance between a tapered tube neck of the tube and the top bead to be equal to or less than a distance between the top bead and the bottom bead.

17. The method according to claim 12, further comprising:
configuring an arc angle of the top bead surrounding the tube to be in a range of from 180 to 360°.

18. The method according to claim 12, further comprising:
configuring the top bead to include a plurality of sections each of which is equally spaced around a circumference of the bottom end.

19. The method according to claim 12, further comprising:
roll flattening the tube to form the flattened sides.

20. A method for removing a tube-and-fin assembly in a cooling core assembly, comprising:
preparing a tube removal tool, wherein part of the tube removal tool is configured to fit in a section between a top bead and a bottom bead in a tube of the tube-and-fin assembly;
firmly gripping the section between the top bead and the bottom bead with the part of the tube removal tool; and
dissociating the bottom bead from a coolant manifold by moving the tube with the tube removal tool, wherein the bottom bead is pulled up and separated from the coolant manifold, wherein the tube-and-fin assembly comprises:
an elongated body having flattened sides, a cylindrical top end and a cylindrical bottom end for attachment to the coolant manifold, wherein the bottom end comprises the bottom bead and the top bead; and
a plurality of fins which are disposed as a unitary part of a corrugated sheet affixed to either side of the tube.
